(19) United States
(12) Patent Application Publication
(10) Pub. No.: US 2010/0332253 A1
(43) Pub. Date: Dec. 30, 2010

(54) Systems and Methods for Providing Customized Dentures

(76) Inventors: Prasad Adusimilli, Parsippany, NJ (US); Stanley J. Lech, Parsippany, NJ (US); Zvi G. Loewy, Parsippany, NJ (US)

Correspondence Address: GlaxoSmithKline;GLOBAL PATENTS -US, UW2220, P. O. BOX 1539, KING OF PRUSSIA, PA, 19406-0939, US

(21) Appl. No.: 12/918,336

(22) PCT Filed: Feb. 20, 2009
(86) PCT No.: PCT/US09/34734

§ 371 Date: Aug. 19, 2010

Related U.S. Application Data
(60) Provisional application No. 61/030,810, filed on Feb. 22, 2008.
(60) Provisional application No. 61/030,795, filed on Feb. 22, 2008.
(60) Provisional application No. 61/030,826, filed on Feb. 22, 2008.
(60) Provisional application No. 61/030,831, filed on Feb. 22, 2008.
(60) Provisional application No. 61/030,842, filed on Feb. 22, 2008.

(51) Int. Cl. G06Q 50/00; A61C 7/00

(52) U.S. Cl. 705/2; 433/215

(57) ABSTRACT

This disclosure relates to system and method for digitally obtaining, recording utilizing and customizing dental data and features needed in providing customized dentures.

### CROSS REFERENCE TO RELATED APPLICATIONS

This application claims the benefit of U.S. Provisional Application Ser. Nos. 61/030,810, 61/030,795, 61/030,826, 61/030,831, and 61/030,842, all filed on Feb. 22, 2008, the contents of each of which are incorporated by reference herein. In addition, this application is related to International Application Serial Nos. PCT/US09/34645, [Attorney Docket No. 0005583WOU], [Attorney Docket No. 0005584WOU], PCT/US09/34670, and [Attorney Docket No. 0005586WOU], all filed contemporaneously with the present application, the contents of each of which are incorporated by reference herein.

### BACKGROUND OF THE INVENTION

1. Field of the Invention

The present disclosure relates to systems and methods for providing customized dentures. More particularly, the present disclosure relates to systems and methods that automate and standardize the collection of denture prescription data of an edentulous patient in digital form, as well as automatically providing this digital prescription data to a denture manufacturing lab for use in denture fabrication, and the fabrication of dentures by the denture factory.

2. Description of Related Art

Dentures are worn in the mouth to replace missing teeth. The term “denture(s)” is used herein to refer to full dentures or partial dentures, both upper and lower types, artificial teeth, removable orthodontic bridges and denture plates, both upper and lower types, orthodontic retainers and appliances, protective mouthguards, nightguards to prevent bruxism and/or temporomandibular joint (TMJ) disorder, and the like.

Current edentulous patients have, in essence, two options for obtaining dentures.

The first option is to purchase non-customized or semi-customized dentures. Such non-customized dentures are used by many edentulous patients due to their low cost, quick availability (e.g., single visit to the dental practitioner), and ease of purchase. Unfortunately, non-customized dentures typically provide the edentulous patients with poor or uncomfortable fit and, often, poor aesthetics.

Alternately, edentulous patients can elect to purchase dentures customized to their mouth. Such customized dentures are used by many edentulous patients due to their comfortable fit and pleasing aesthetics. Unfortunately, current customized dentures suffer from drawbacks that include high cost, multiple visits to the dental practitioner, and long lead times to obtain the denture.

Furthermore, the current processes for collecting denture prescription data, as well as manufacturing customized dentures, involve multiple steps that require the dental practitioner to manually obtain patient data and translate this patient data into a written prescription for the denture. This written prescription is then forwarded to a denture lab, where a denture laboratory technician deciphers the written prescription and builds the customized denture. Because the data collection and the denture manufacturing are labor-intensive processes and have a great deal of subjective measuring and interpretation on the part of the dental practitioner and the denture technician, respectively, the fit and finish of customized dentures is often times highly dependent on the skill of those professionals. Thus, many customized dentures, even though more costly and time consuming to prepare, often suffer from many of the drawbacks suffered by those edentulous patients who purchase non-customized dentures, such as poor or uncomfortable fit and, often, poor aesthetics.

Accordingly, it has been determined by the present disclosure that there is a need for systems and methods for providing customized dentures that overcome, alleviate, and/or mitigate one or more of the aforementioned and other deleterious effects of prior art customized denture processes (e.g., high cost, multiple dental visits, long lead times, and process subjectivity), while affording one or more of the aforementioned and other advantageous effects of prior art non-customized denture processes (e.g., low cost, quick availability, and ease of purchase), yet maintaining or improving upon the aforementioned and other advantageous effects of prior art customized denture processes (e.g., comfortable fit and pleasing aesthetics).

### BRIEF SUMMARY OF THE INVENTION

The present disclosure relates to systems and methods for streamlining the manual process of obtaining, recording, processing and manipulating the mouth data of an edentulous patient. The system and method use digital technology to enable dental practitioners to provide consistent and better quality care, and better quality dentures (referring to the form, fit and function of the dentures), to their patients. The systems and methods of the present disclosure also allow for quantitative analysis of the data, standardization of care and appropriate treatment guidance, making the dental office efficient and reducing errors that can affect patient treatment.

In one aspect, the present disclosure relates to systems and methods for obtaining, recording, processing and/or manipulating digital data of an edentulous patient. In a further aspect, the present disclosure relates to methods for utilizing digital data of an edentulous patient to formulate a data protocol for manufacturing a denture. In still a further aspect, the present disclosure relates to methods for transferring digital data of an edentulous patient to a dental laboratory for use in manufacturing a denture.

The present disclosure also relates to pre-fabricated, dental arch-shaped molds containing one or more artificial teeth attached thereto. In a further aspect, the present disclosure relates to methods for constructing a denture using a pre-fabricated, dental arch-shaped mold containing one or more teeth attached thereto. Using the disclosed pre-fabricated device and method, the denture laboratory technician saves a great deal of time in fabricating a denture since the artificial teeth will be substantially in the proper arrangement for placement on the denture base. In addition, the devices and methods of the present disclosure standardize the process and reduce the variability in placement of teeth, which reduces the cost of dentures to the patient without compromising quality.

Further, the present disclosure relates to apparatuses and methods for obtaining one or more digital images of an edentulous patient to provide varying images of the patient's facial features and measurements relative to measurements within the patient's mouth.

A system for providing a customized denture for an edentulous patient is provided. The system includes a dental office module and a dental laboratory module in electrical communication with the dental office module via a communication medium. The dental office module collects digital denture prescription data of the edentulous patient and the dental laboratory module fabricates the customized denture based on the digital denture prescription data.

A method for providing customized dentures for an edentulous patient is provided. The method includes collecting digital denture prescription data of the edentulous patient at an office of a dental practitioner; transmitting the digital denture prescription data to a denture laboratory; and fabricating the customized denture based on the digital denture prescription data.

The above-described and other features and advantages of the present disclosure will be appreciated and understood by those skilled in the art from the following detailed description, drawings, and appended claims.

### BRIEF DESCRIPTION OF THE SEVERAL VIEWS OF THE DRAWINGS

FIG. 1 is a first schematic depiction of an exemplary embodiment of a custom denture system according to the present disclosure;

FIG. 2 is a second schematic depiction of the custom denture system of FIG. 1;

FIG. 3 is an exemplary embodiment of a patient examination screen of an office module of the system of FIG. 1;

FIG. 4 is an exemplary embodiment of a first quantitative measurement screen and a second quantitative measurement screen of the office module of the system of FIG. 1;

FIG. 5 illustrates exemplary embodiments of images and measurements obtained by a third quantitative measurement screen of the office module of the system of FIG. 1;

FIG. 6 illustrates an exemplary embodiment a digital data collection device for capturing the images and measurements of FIG. 5;

FIG. 7 is an exemplary embodiment of a tooth selection screen of the custom denture data collection system of FIG. 3;

FIG. 8 is an exemplary embodiment of a denture manufacturing laboratory during a denture manufacturing step according to the custom denture system of FIG. 1;

FIG. 9 is an exemplary embodiment of a pre-fabricated, dental arch-shaped mold containing one or more artificial teeth for use with the custom denture system of FIG. 1; and

FIG. 10 is a schematic depiction of the pre-fabricated, dental arch-shaped mold of FIG. 9 in use with the custom denture system of FIG. 1.

### DETAILED DESCRIPTION OF THE INVENTION

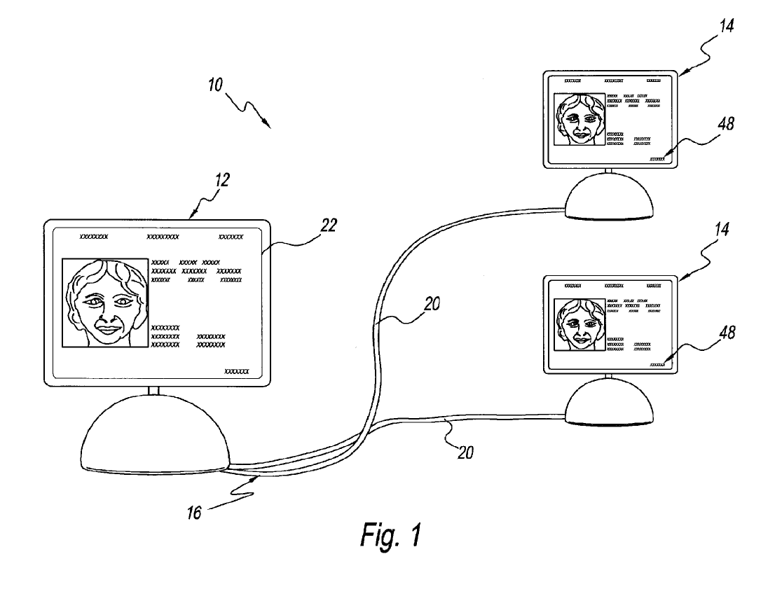

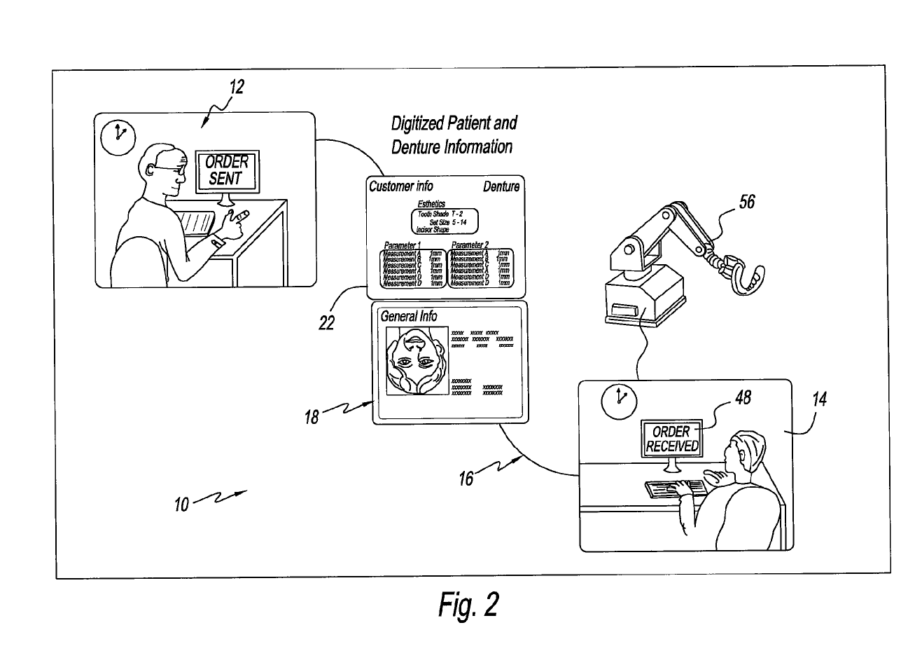

Referring now to the drawings and in particular to FIGS. 1 and 2, an exemplary embodiment of a custom denture system according to the present disclosure is shown and is generally referred to by reference numeral 10. System 10 includes a dental office module 12 and one or more dental laboratory modules 14 in electrical communication with the office module via a communication medium 16.

Advantageously, system 10 provides the dental practitioner with an easy to use and repeatable means to collect digital denture prescription data and transmit this digital prescription data to a dental laboratory technician. Additionally, system 10 provides the dental laboratory technician with an easy and repeated means to fabricate the desired denture using the digital denture prescription data.

Dental office module 12 provides an interface to system 10 for the dental practitioner, allowing the dental practitioner to automate and standardize the collection of denture prescription data 18 of an edentulous patient in a digital form. The term “dental practitioner(s)” is used herein to refer to those practitioners resident at a dental office who interact with the edentulous patient.

Dental laboratory module 14 provides an interface to system 10 for the denture laboratory technician, allowing the denture laboratory technician to retrieve the digital denture prescription data 18 and convert this digital data, using automated and/or semi-automated manufacturing processes, into the desired denture. The term “denture laboratory technician(s)” is used herein to refer to the workers involved with fabricating dentures based on prescription data provided by the dental practitioner.

Communication medium 16 can be any known method of providing the digital prescription data 18 from office module 12 to laboratory module 14. In the illustrated embodiment, communication medium 16 is a wired network 20 placing modules 12, 14 in electrical communication with one another. It is contemplated by the present disclosure for wired network 20 to include any wired network such as, but not limited to, the Internet, a wide-area network (WAN), a local-area network (LAN), and others. However, it is also contemplated by the present disclosure for communication medium 16 to be any wireless network sufficient to wirelessly transmit the digital prescription data 18 from office module 12 to laboratory module 14. Further, it is contemplated by the present disclosure for communication medium to be any physical storage medium (e.g., a floppy disk, a compact disk, a flash drive) having the digital prescription data 18 stored thereon, which can be physically transferred from the location where office module 12 is resident to the location where laboratory module 14 is resident.

System 10 reduces the complexity in the current process utilized by some of the well known dental practitioners and laboratory technicians. System 10 makes the denture process simpler and faster, take less time, require fewer appointments, while maintaining or enhancing the quality of dentures as compared to prior art standardized and customized dentures. The term “quality” as used herein refers to the form, fit, function and aesthetic properties of the dentures. Thus, system 10 provides systems and methods for providing customized dentures that are simpler and faster and require fewer steps to accomplish either the same or improved end result as compared to prior art customized denture systems.

Office module 12 provides the dental practitioner an interface to a plurality of interactive data entry screens 22 resident on system 10 and/or the office module that lead the dental practitioner through the digital prescription process.

Interactive data entry screens 22 include a plurality of digital prescription data collection steps, which can include one or more of examination of the patient, determine lip pull and vertical dimension, determine digital impression of the oral cavity, preparing custom base plates from the digital impression, determine an aesthetic blue print record base, determine a neutral zone record base, determining face bow records, determining articulator records, and any combinations thereof.

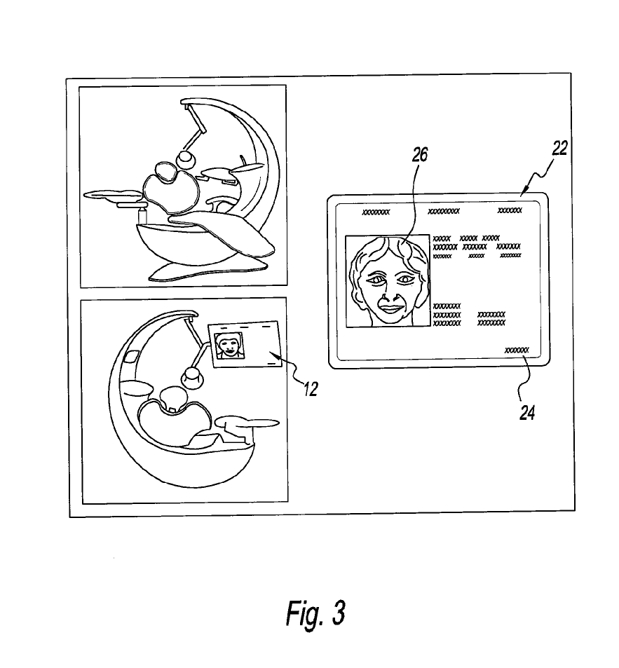

Referring now to FIGS. 3 through 7, exemplary embodiments of interactive data entry screens 22 of office module 12 are shown.

FIG. 3 provides one or more data entry screens 22 for patient examination and capturing all of the patient history and facial features and anatomical features of the oral cavity. Here, office module 12 presents examination screens 24 providing a series of medical questions to the dental practitioner related to the facial features and anatomical features of the oral cavity. Each question of examination screen 24 has pictorial examples 26 so that the dental practitioner can select the pictorial example that best approximates the patient's anatomy. It has been determined by the present disclosure that selection of pictorial examples 26 reduces the variability and minimize the subjectivity that currently exists in the examination process of prior art customized denture processes.

Office module 12 also provides one or more data entry screens 22 for taking a plurality of quantitative measurements of the oral cavity for variables determined by the present disclosure to be key indicators of denture quality. The quantitative measurements can include measurements such as, but not limited to, the intercanthus, interala, tongue size, height and width of lower and upper ridges at several points, lip pull, bite requirements, vertical dimension, occlusal plane, and any combinations thereof. Such measurements allow for quantitative analysis of the data and standardization of care and allow for appropriate treatment guidance.

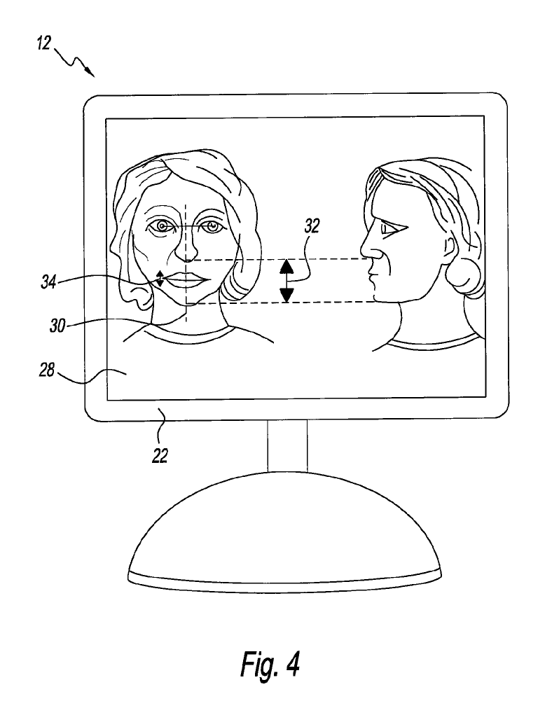

FIG. 4 illustrates exemplary data entry screens 22 for quantitative measurement of lip pull and vertical dimension, respectively. More particularly, office module 12 provides the dental practitioner with a centerline, lip pull, and vertical dimension screen 28 that provides step-by-step instructions on how to measure or identify the patient's center line 30 and provides a location or field to enter this information digitally using these instructions. In addition, screen 28 provides step-by-step instructions on how to measure the patient's vertical dimension 32 and provides a location or field to enter the vertical dimension measurement digitally using these instructions. Further, screen 28 provides step-by-step instructions on how to measure the patient's lip pull dimension 34 and provides a location to enter the dimension measurement digitally using these instructions.

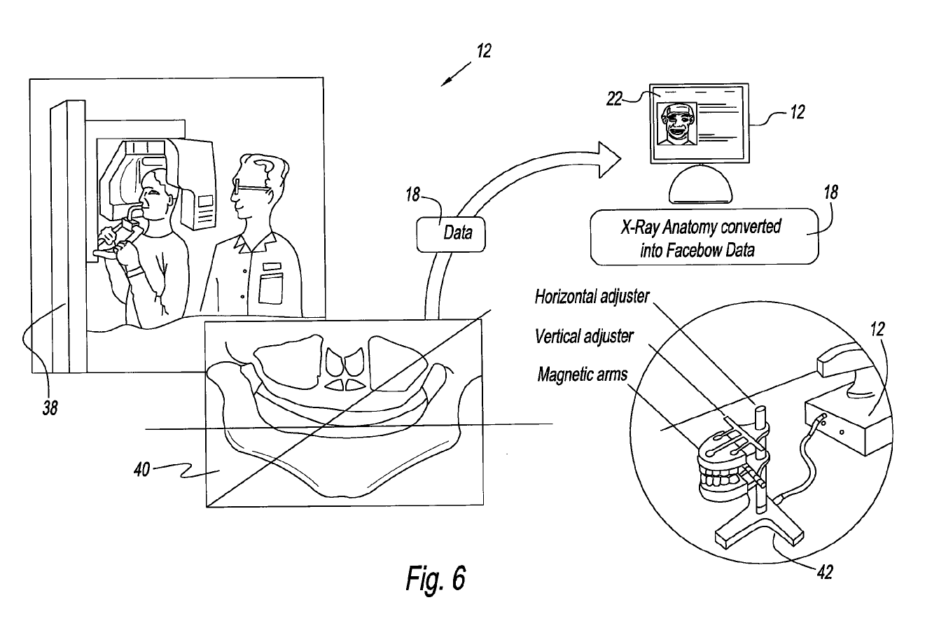

In some embodiments, office module 12 can interface with a three-dimensional face scanning device 38 (shown in FIG. 6) that facilitates assessment of lip pull, center line, and vertical dimension and directly enters this digital data into office module 12.

In other embodiments, office module 12 can interface with a scanning device such as that shown and described in commonly owned and assigned U.S. application Ser. No. 12/307,608 filed Jul. 2, 2007, the contents of which are incorporated by reference herein, where the scanning device uses an optical source to take data representing the shape of the patient's denture template.

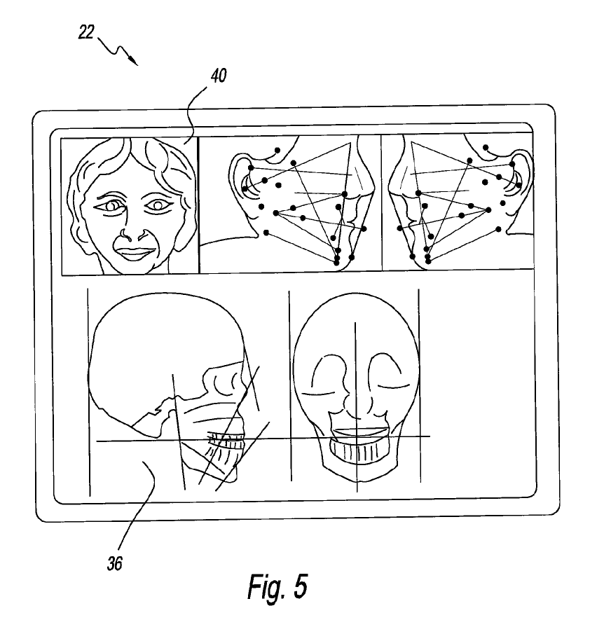

FIGS. 5 and 6 illustrate data entry screens 22 for quantitative measurement of the patient's occlusal plane. Here, office module 12 provides the dental practitioner with an occlusal plane screen 36 that instructs the dental practitioner to use one or more measuring devices such as a panoramic or three-dimensional scanning device 38 to provide one or more images 40 of the patient's anatomy. Office module 12 uses images 36 to develop a relationship of the patient's gums to the temporomandibular joint (TMJ), which eliminate the requirement for a face bow and electronically determines the occlusal plane and relationship of the upper jaw to the TMJ. In addition, office module 12 uses images 36 to determine the occlusal plane. The term “three-dimensional scanning device” is used herein to refer to devices such as, but not limited to, panoramic X-ray machines, magnetic resonance imaging (MRI) machines, bone scan machines, and others.

As shown in FIG. 6, office module 12 can transfer the occlusal plane data from occlusal plane screen 36 along with other data such as, but not limited to, face bow data directly to a programmable articulator 42 for use by the dental practitioner during the digital prescription data 18 collection process. In some embodiments, programmable articulator 42 can be as described in commonly owned International Patent Application No. [Attorney Docket No. 0005583WOU].

It should be recognized that the present disclosure illustrates by way of example the manual measurement and entry into office module 12 of certain quantitative attributes (e.g., lip pull, center line, and vertical dimension) and the automatic measurement and entry into office module 12 of other quantitative attributes (e.g., occlusal plane). Of course, it is contemplated by the present disclosure for all of the quantitative attributes to be manually measured and entered, all of quantitative attributes to be automatically measured and entered, or any combinations thereof.

In some embodiments, office module 12 allows the dental practitioner to assess the rate of bone resorption by a particular patient. More particularly, it has been determined that the measurement of the height and width of the upper and lower gummy ridges can be stored and compared to one another during subsequent visits to the dental practitioner. In this manner, system 10 compares dimensions of the upper and lower gummy ridges over a period of time to assess the rate of bone resorption and, if necessary, allow the dental practitioner to provide therapeutic intervention.

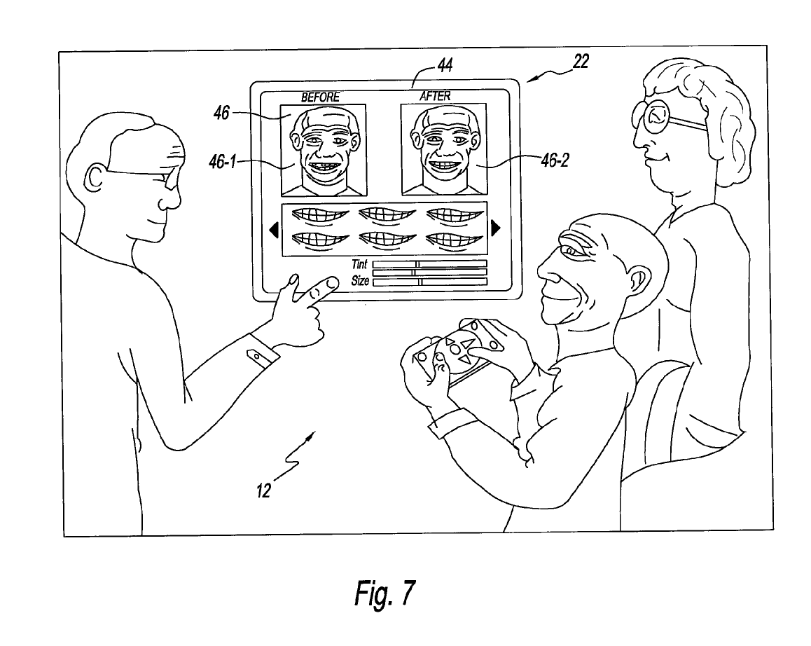

In addition to the one or more examination screen 24 (e.g., FIG. 3) and the one or more quantitative measurement screens 28, 36 (FIGS. 4-6) discussed above, office module 12 can also include one or more patient qualitative data screens 44 as shown in FIG. 7.

Patient qualitative data screens 44 allow the patient to select one or more qualitative attributes of the finished denture. For example, patient qualitative data screens 44 can allow the patient to select one or more features of the finished denture such as, but not limited to, tooth size, gum size, tooth placement, tooth color or tint, gum color or tint, and other features.

In some embodiments, such as that disclosed in more detail in commonly owned International Patent Application No. PCT/US09/34645, patient qualitative data screens 44 can present the patient with their own picture or image 46 such that the selection of the qualitative features (e.g., tooth size, tooth placement, tooth color or tint) is made with relation to the patient's own face. Thus, picture 46 provides the patient with realistic visual images to help with selection of the various attributes of the completed denture.

Office module 12, via patient qualitative data screens 44, allows the patient to look at him or herself before and after the dentures having the selected qualitative features are in place. Preferably, office module 12, via patient qualitative data screens 44, distorts or modifies picture 46 to simulate and adjust the vertical dimension, center line, and lip pull to reflect the patient's preference. In this manner, office module 12, via patient qualitative data screens 44, distorts or modifies picture 46 to provide a before picture 46-1 and an after picture 46-2 to better inform the patient of the effects of the qualitative features selected via data screens 44.

Having a choice of all of these features and the ability to visualize them enables the patient to make an appropriate selection based on their personal preferences. The selected qualitative features, as well as the resultant picture 46-2, is included in the digital dental prescription data 18. Since, the patient is able to view him or herself in various configurations and selects the preferred look; the resulting denture provides a much higher satisfaction than previously possible. In summary, office module 12 allows the patient to have a virtual “try-in” of dentures having different qualitative features, which reduces the number of visits to the dental practitioner.

By way of example, it is contemplated by the present disclosure for image 40 provided by scanning device 38 discussed above with respect to FIG. 6 to be used by office module 12 as picture 46.

Accordingly and as described above, office module 12 advantageously allows for standardization of the measurements and data collection necessary for the generation of digital prescription data 18. Office module 12 allows the dental practitioner to populate all of the fields required by digital prescription data 18. In this manner, at the end of the visit to the dental practitioner, the digital prescription data 18 is consistently gathered for provision to the laboratory technician and ensures that consistently good quality dentures are fabricated, while reducing the time required by the dental practitioner to prepare the digital prescription data 18.

Office module 12 guides the dental practitioner through each of the steps in obtaining digital prescription data 18. Also, for each of the steps, the office module 12 provides the list of materials and tools required by the dental practitioner.

The digital prescription data 18 will include information such as, but not limited to, the name of the patient, a digital photograph of the patient, the selected smile option, the color, shape, size of teeth, the selected customization of teeth placement etc. In addition, quantitative measurements taken for many of the key variables such as intercanthus, interala, tongue size, height and width of lower and upper ridges at several points, lip pull, bite requirements, vertical dimension etc., will be included in the digital prescription data 18.

In summary, office module 12 serves the comprehensive needs of the dental practitioner via automating the process of collecting digital prescription data 18, eliminating errors that result from paper-based prescriptions, enhance the quality of dentures and reduce complexity for the dental laboratory.

Once the digital denture prescription data 18 is collected by office module 12, system 10 communicates the data to laboratory module 14 via communication medium 16.

Laboratory module 14 guides the dental laboratory technician through each of the steps in fabricating the dentures using the digital prescription data 18 captured by the dental practitioner. For example, and referring back to FIGS. 1 and 2, laboratory module 14 provides the dental practitioner an interface to a plurality of interactive data screens 48 resident on system 10 and/or the office module that lead the dental practitioner through the digital prescription process.

By doing this, laboratory module 14 maintains the patient record up-to-date and at any given time, for any given patient, the patient record will indicate the steps that have been completed and the next task to be conducted. Also, for each of the steps, the laboratory module 14 provides the list of materials and tools required.

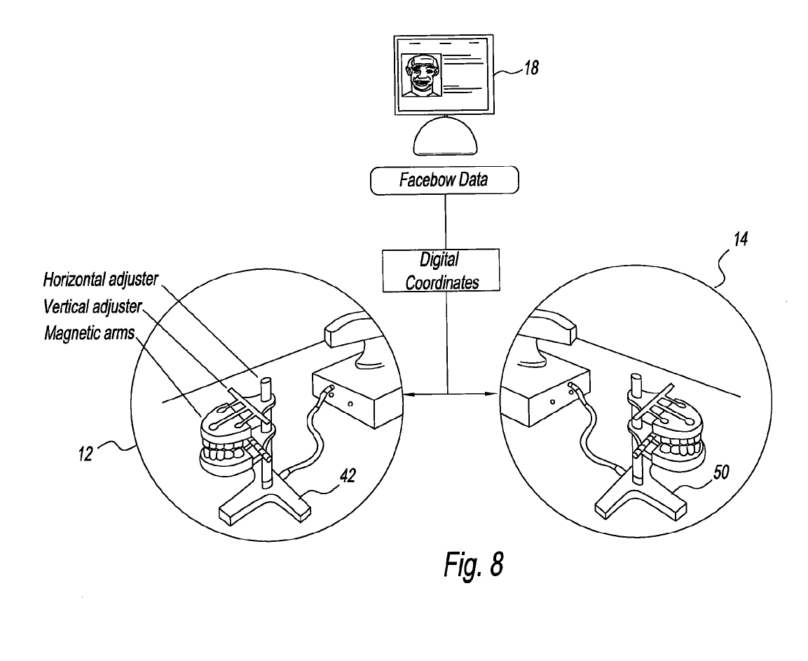

As discussed briefly above with respect to FIGS. 5 and 6, office module 12 can transfer the occlusal plane data from occlusal plane screen 36 directly to a programmable articulator 42 for use by the dental practitioner during the digital prescription data 18 collection. In addition or in the alternate, system 10 can transfer the data 18 to laboratory module 14, which is in communication with a programmable articulator 50 for use by the dental laboratory technician as shown in FIG. 8.

In addition, programmable articulator 50 can assist the laboratory technician in determining teeth placement in accordance with Wilson and Spee curves, bite registration, and the aesthetic blue print from the digital prescription data 18. In some embodiments, programmable articulators 42 and 50 can be as described in commonly owned International Patent Application No. [Attorney Docket No. 0005583WOU].

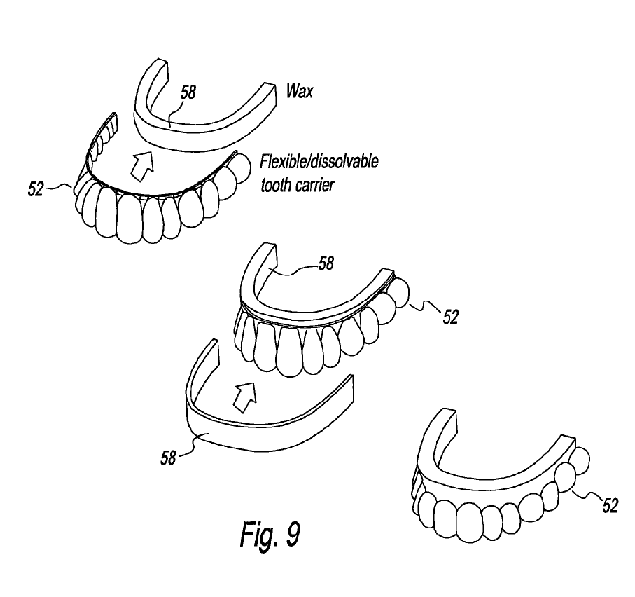

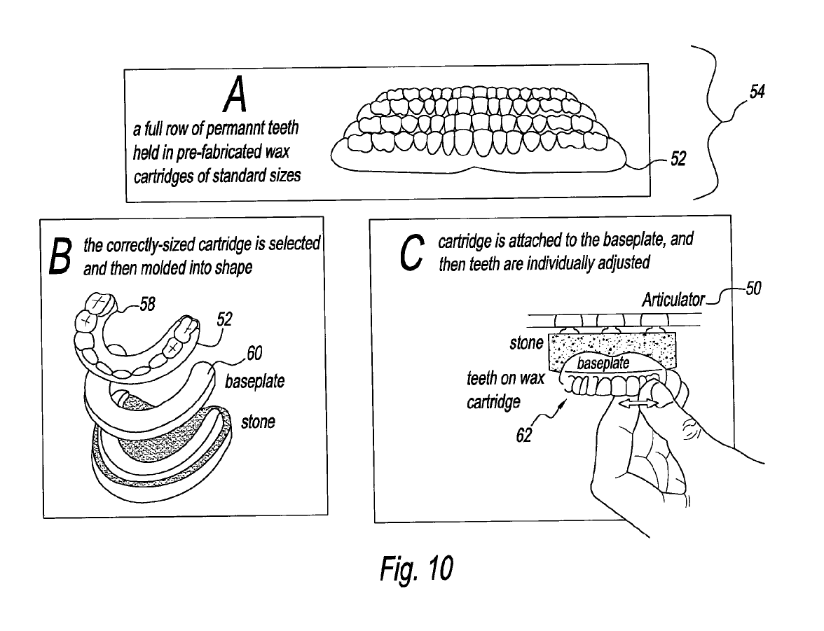

Referring now to FIGS. 9 and 10, laboratory module 14 can use digital prescription data 18 to select a pre-fabricated, dental arch-shaped mold 52 containing one or more artificial teeth attached thereto.

In some embodiments, laboratory module 14 uses digital prescription data 18 to select a particular pre-fabricated, dental arch-shaped mold 52 from a plurality of molds 54, where the selected mold 52 best approximates the aesthetic and other attributes present in the digital prescription data. Here, the plurality of molds 54 each include artificial teeth that are attached to the mold in various standardized configurations so that laboratory module 14 can select the best fit for the desired denture.

In a different embodiment, the teeth are placed individually on the mold 52 using automated manufacturing methods, including, but not limited to, using a robotic arm 56 (FIG. 2). Here, laboratory module 14 uses data 18 to set the teeth in the mold based on the size and shape of the dental arch and the desired size, style and color of teeth to be placed.

Once the dental arch-shaped mold 52 is selected and/or robotically formed, the mold is shaped into a desired position using one or more layers 58 of wax or flexible and water-soluble material, including, but not limited to polyethylene glycol.

In some embodiments, the dental arch-shaped mold 52, including the preformed version and the robotically assembled version discussed above, is made of a wax, light cure polymethyl methacrylate (PMMA), or flexible and water soluble material, including, but not limited to polyethylene glycol.

Once the dental arch-shaped mold 52 is shaped using layers 58, the mold is then bonded to a base plate 60 with the assistance of heat and wax. In one embodiment, a small layer of wax is melted with a hot spatula and adhered to the base plate and, while this wax layer is still in molten form, the wax tooth carrier 52 is placed on the denture base plate 60 and pressed to bond to a molten wax layer already on the base plate. Once the dental arch-shaped mold 52 is in place on base plate 60, the laboratory technician is able to check occlusion of teeth and make any necessary adjustments to the relative position of the teeth using articulator 50. The laboratory technician can also verify and make sure that the teeth are following the Wilson and Spree curves, which specify the angles of teeth from side to side and front to back. The resultant wax denture 62, upon approval by the patient and dentist, is then processed to obtain the final denture using a known lost wax technique.

Referring again to FIG. 2, laboratory module 14 can include one or more automated manufacturing devices. For example, laboratory module 14 can include robotic arm 56 such as, but not limited to, those manufactured by Denso Robotics, Fanuc, Mitsubhishi, and others. Laboratory module 14 can divide the fabrication process of dentures into many unit operations to simplify and automate the process. Each unit operation of laboratory module 14 is designed into a robotic cell with robotic arm 56 moving the denture in process among the unit operations.

In summary, system 10 serves the comprehensive needs of both the dental practitioner and the laboratory practitioner and provides multiple benefits such as an examination tool, denture fabrication guide that takes the dental practitioner through each of the steps and a database that captures all pertinent data.

In another embodiment, system 10 can also provide all of the financial analysis and accounting tools required for analyzing the effectiveness of denture practice and automate the receipt and payment of invoices.

It should also be noted that the terms “first”, “second”, “third”, “upper”, “lower”, and the like may be used herein to modify various elements. These modifiers do not imply a spatial, sequential, or hierarchical order to the modified elements unless specifically stated.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of the appended claims.

What is claimed is:

1. A system for providing a customized denture for an edentulous patient, comprising:
a dental office module; and
a dental laboratory module in electrical communication with said dental office module via a communication medium, said dental office module being configured to collect digital denture prescription data of the edentulous patient and said dental laboratory module being configured to fabricate the customized denture based on said digital denture prescription data.

2. The system of claim 1, wherein said communication medium is selected from the group consisting of a wired network, a wireless network, a transferable physical storage medium, and any combinations thereof.

3. The system of claim 1, wherein said dental office module comprises a plurality of interactive data entry screens that provide instructions to a dental practitioner to collect said digital denture prescription data.

4. The system of claim 3, wherein said dental office module comprises examination screens providing a series of medical questions to the dental practitioner related to features of the edentulous patient.

5. The system of claim 4, wherein each question of said series of medical questions has a plurality of pictorial examples so that the dental practitioner can select a pictorial example from said plurality that best approximates the features of the edentulous patient.

6. The system of claim 1, wherein said dental office module comprises one or more data entry screens for taking a plurality of quantitative measurements of features of the edentulous patient.

7. The system of claim 6, wherein said plurality of quantitative measurements are selected from the group consisting of measurements of intercanthus, interala, tongue size, height and width of lower and upper ridges at several points, lip pull, bite requirements, vertical dimension, occlusal plane, and any combinations thereof.

8. The system of claim 6, further comprising a three-dimensional face scanning device in electrical communication with said dental office module, said three-dimensional face scanning device being configured to determine at least some of said plurality of quantitative measurements.

9. The system of claim 8, further comprising an occlusal plane screen using images from said three-dimensional face scanning device to develop an occlusal plane of the edentulous patient.

10. The system of claim 9, further comprising a programmable articulator in electrical communication with said dental office module, said programmable articulator being set to a desired position by said dental office module based on said digital prescription data.

11. The system of claim 6, wherein at least some of said plurality of quantitative measurements are manually measured and entered into said one or more data entry screens.

12. The system of claim 6, wherein at least some of said plurality of quantitative measurements are automatically measured and entered into said one or more data entry screens by a measuring device.

13. The system of claim 1, wherein said dental office module is configured to assess a rate of bone resorption by comparing a height and width of the upper and lower gummy ridges of the edentulous patient taken during a first visit to a height and width of the upper and lower gummy ridges of the same edentulous patient taken during a second visit.

14. The system of claim 1, wherein said dental office module comprises one or more patient qualitative data screens.

15. The system of claim 14, wherein said one or more patient qualitative data screens are configured to allow the edentulous patient to select one or more aesthetic features of the customized denture.

16. The system of claim 15, wherein said one or more aesthetic features comprises a feature selected from the group consisting of tooth size, gum size, tooth placement, tooth color or tint, gum color or tint, and any combinations thereof.

17. The system of claim 15, wherein said one or more patient qualitative data screens comprise a picture of the edentulous patient such that selection of said one or more aesthetic features is made with relation to the edentulous patient's own face.

18. The system of claim 1, further comprising a programmable articulator in electrical communication with said dental laboratory module, said programmable articulator being set to a desired position by said dental laboratory module based on said digital prescription data.

19. The system of claim 1, wherein said dental laboratory module is configured to use said digital denture prescription data to select a particular pre-fabricated, dental arch-shaped mold having teeth therein from a plurality of molds.

20. The system of claim 1, wherein said dental laboratory module is configured to place teeth in a dental arch-shaped mold based on said digital denture prescription data.

21. A method for providing customized dentures for an edentulous patient, comprising:
collecting digital denture prescription data of the edentulous patient at an office of a dental practitioner;
transmitting said digital denture prescription data to a denture laboratory; and
fabricating the customized denture based on said digital denture prescription data.

22. The method of claim 21, wherein collecting said digital denture prescription data comprises providing a plurality of interactive data entry screens to a dental practitioner, said plurality of interactive data entry screens comprising instructions to collect said digital denture prescription data.

23. The method of claim 21, wherein collecting said digital denture prescription data comprises:
providing a plurality of medical questions to a dental practitioner related to features of the edentulous patient;
providing a plurality of pictorial examples with each of said plurality of medical questions; and
requiring the dental practitioner to select a pictorial example from said plurality that best approximates the features of the edentulous patient.

24. The method of claim 21, wherein collecting said digital denture prescription data comprises taking a plurality of quantitative measurements of features of the edentulous patient.

25. The method of claim 24, wherein said plurality of quantitative measurements are selected from the group consisting of measurements of intercanthus, interala, tongue size, height and width of lower and upper ridges at several points, lip pull, bite requirements, vertical dimension, occlusal plane, and any combinations thereof.

26. The method of claim 24, wherein taking said plurality of quantitative measurements comprises taking a three-dimensional face scan of the edentulous patient.

27. The method of claim 26, further comprising determining an occlusal plane screen based on said three-dimensional face scan.

28. The method of claim 21, wherein collecting said digital denture prescription data further comprises assessing a rate of bone resorption by comparing a height and width of the upper and lower gummy ridges of the edentulous patient taken during a first visit to a height and width of the upper and lower gummy ridges of the same edentulous patient taken during a second visit.

29. The method of claim 21, wherein collecting said digital denture prescription data further comprises allowing the edentulous patient to select one or more aesthetic features of the customized denture.

30. The method of claim 29, further comprising displaying an image of the edentulous patient based on said one or more aesthetic features with relation to the edentulous patient's own face.
